(19) United States
(12) Patent Application Publication
(10) Pub. No.: US 2008/0232193 A1
(43) Pub. Date: Sep. 25, 2008

(54) Methods for Noise Removal and/or Attenuation from Seismic Data by Wavelet Selection

(75) Inventor: PING AN, KATY, TX (US)

Correspondence Address: ALBERTO Q. AMATONG, JR., P.O. BOX 70889, HOUSTON, TX, 77270-0889, US

(73) Assignee: GEOCYBER SOLUTIONS, INC., KATY, TX (US)

(21) Appl. No.: 11/563,204

(22) Filed: Mar. 20, 2007

(51) Int. Cl. G01V 1/28

(52) U.S. Cl. 367/38

(57) ABSTRACT

Seismic data traces contain noises that may exist in the form of wavelets and be represented by wavelets. A method is established for removing or attenuating the noises in the seismic data traces by removing the wavelets or representing wavelets of noises in the seismic data traces. The method involves three steps. (1) Decomposition of each seismic data trace into a set of time dependent wavelets of different shapes. The obtained wavelets can be named with their dominant frequency or other characteristics of the wavelets. (2) Proper selection of the wavelets to form a new set of wavelets that contains mostly signal wavelets and rejects the wavelets of noises and representing wavelets of noises as mush as possible. This step can also be described as to remove the wavelets of noises and representing wavelets of noises from the obtained set of wavelets from step one and form a new set of wavelets. (3) Composition or reconstruction of a new seismic data trace with the new selected set of wavelets. The new reconstructed seismic data trace is the resulting seismic data trace. It normally have much higher signal to noise ratio than the original seismic data trace.

### FIELD OF THE INVENTION

The present invention relates generally to the field of seismic exploration for resources such as petroleum. Specifically, the invention relates to the field of seismic data processing and interpretation. More specifically, the invention relates to noise removal from seismic data traces in seismic data processing and interpretation.

### BACKGROUND OF THE INVENTION

In seismic prospecting, a seismic source is used to generate a seismic wave that propagates into the earth and is at least partially reflected by subsurface seismic reflectors. The reflected signals are recorded by seismic receivers located at or near the surface of the earth, in an overlying body of water, or at known depths in boreholes, and the resulting seismic data are seismic data traces and may be processed to yield information relating to the subsurface formations.

Seismic prospecting consists of three separate stages: data acquisition, data processing, and data interpretation. The seismic energy recorded by each seismic receiver is known as a “seismic data trace”. It is actually stored on a computer as a series of digital amplitude samples. Seismic data traces typically contain both the desired seismic reflections and one or more unwanted noise components that can overwhelm the wanted seismic reflections.

One method for attenuating unwanted noise components in seismic data traces is through the common-midpoint (CMP) stacking process. The “midpoint” for a seismic data trace is the point midway between the source location and the receiver location for that trace. According to the CMP method, the recorded seismic data traces are sorted into common-midpoint gathers each of which contains a number of different seismic data traces of the same midpoint but different source-to-receiver offset distances. The seismic data traces within each CMP gather are corrected for statics and normal moveout and are then summed or “stacked” to yield a stacked data trace which is a composite of the individual seismic data traces in the CMP gather. Before the summing process, the individual seismic data traces are normally called pre-stack seismic traces. After the summing process, the summed or stacked data traces are normally called post-stack seismic traces. Typically, the post-stack data trace has a significantly improved signal-to-noise ratio compared to that of the pre-stack seismic data traces.

A seismic data trace that can be either pre-stack or post-stack contains wavelets that are reflected from petrophysical or lithological boundaries or reflectors in subsurface at different depth. The seismic data trace also contains noises that also exist in the form of wavelets.

Frequency filtering is a commonly used method to attenuate noises in seismic data processing and interpretation. There are different ways to perform the frequency filtering, such as convolution of the seismic data trace with a filter coefficient series or filter operator in time domain or multiplication of the amplitude spectrum with a frequency pass gate function. One of the commonly used methods is, for example, to first design a frequency pass gate in frequency domain, compute the frequency spectrum of the seismic data trace by Fourier Transform, and then multiple the spectrum with the frequency gate and perform the reverse Fourier Transform. This processing rejects the frequency content that in the seismic data trace and outside the frequency gate. The result from reverse FFT should be the filtered seismic data trace. For more details on frequency filtering, please refer to Yilmaz (2001).

Frequency filtering is based on Fourier Transform. It essentially rejects certain frequency content outside the frequency pass gate in the seismic data trace. It can attenuate the noise in the seismic data trace if the frequency content of the signal is not significantly overlap with the frequency content of the noise and the frequency content of the noise is largely outside the frequency pass gate. It, however, attenuate the signal in some extent because the frequency content of the noise, in most cases, overlaps with the frequency content of the signal.

A recorded seismic data trace contains wavelets that are reflected from petrophysical or lithological boundaries or reflectors in subsurface at different depth. It also contains noises that exist in the form of wavelets.

A method for seismic trace decomposition and reconstruction using multiple wavelets was invented by Ping An (An, 2006). Based on the invention, and different from the commonly used frequency filtering method, this invention establishes a method which can be used to remove the wavelets of the noises from a seismic data trace and hence increase the signal to noise ratio greatly.

### SUMMARY OF THE INVENTION

The present invention has established a method for removing or attenuating noises in the seismic data traces by removing the wavelets or representing wavelets of noises in the seismic data traces.

The new method involves three steps. (1) Decompose the seismic data trace into a set of time dependent wavelets of different shapes. The obtained wavelets can be named with their dominant frequency or other characteristics of the wavelets. An example method to decompose the seismic data traces is the method invented by Ping An (An, 2006). (2) Select properly the wavelets to form a new set of wavelets that contains mostly signal wavelets and rejects wavelets of noises and representing wavelets of noises as mush as possible. This step can also be described as removing the wavelets of noise and representing wavelets of noises from the obtained set of wavelets from step one and form a new set of wavelets. (3) Compose or reconstruct a new seismic data trace with the new set of wavelets. The new reconstructed seismic data trace is the resulting seismic data trace. It normally have much higher signal to noise ratio than the original seismic data trace. An example method of composing the new seismic data trace is the reconstruction method that was invented by Ping An (An, 2006).

FIG. 1 shows a shot gather of original pre-stack seismic data traces. Low frequency and velocity ground roll noises are obvious in the gather. It also contains high frequency noises. Each seismic data trace in the shot gather is first decomposed into a set of Ricker wavelets. And then the wavelets are selected based on the dominant frequency of the wavelets. FIG. 2 shows the reconstruction or composition using the wavelets of dominant frequencies from 16 to 47 Hz. We can see that the noises are mostly removed from the seismic traces. FIG. 3 shows the difference of the seismic traces in FIG. 1 from those of FIG. 2. We can see that almost no signal is removed from the seismic traces. FIG. 4 is the reconstruction of the seismic traces using wavelets of dominant frequencies from 2 to 15 Hz. It shows the low frequency ground roll noises removed from the original seismic data traces. FIG. 5 shows the reconstruction using wavelets of dominant frequencies from 48 to 100 Hz. It is actually the high frequency noises removed from the original seismic data traces.

For comparison with conventional frequency filtering approach, FIG. 6 shows the result of band pass filtering with frequency band 11, 16-47, 52 Hz. It shows the ground roll noises are attenuated but not well removed. FIG. 7 shows the difference of original data before filtering (FIG. 1) and those after filtering (FIG. 6). It is seen that some of the signals are also removed from the seismic traces.

To get the same level result of noise removal as wavelet selection (FIG. 2), the filter band width was reduced to 18, 23-47, 52. The result is shown in FIG. 8. FIG. 9 shows the difference of the original seismic data (FIG. 1) before filtering from those after filtering. It can be seen that much signal energy is also removed from the seismic data.

In more general cases, a wavelet pass polygon of dominant frequency can be designed in frequency time domain. FIG. 10 show an original seismic shot gather with noise of low frequency. FIG. 11 shows the dominant frequency wavelets passing polygon in time-frequency domain. Using the dominant frequency polygon to get rid of the wavelets whose dominant frequencies are outside of the polygon, we obtain a new set of wavelets. New seismic traces of the shot gather can be reconstructed with the new set of wavelets as show in FIG. 12. It can be seen that the noises are mostly removed. FIG. 13 shows the difference of the new seismic data traces (FIG. 12) from the original seismic traces (FIG. 10).

For comparison, FIG. 14 shows the result of conventional frequency filtering of the original seismic data traces (FIG. 10) with band pass 10, 15-35, 40 Hz. It can be seen the noise in FIG. 14 is not as well removed as the wavelet selection result (FIG. 12). The difference of the result of band pass filtering (FIG. 14) from the original (FIG. 10). It shows that some of the signals are also removed.

### REFERENCE

An, Ping, 2006, Method for Seismic Trace Decomposition and Reconstruction Using Multiple Wavelets, U.S. patent application Ser. No. 11/382,042.

Yilmaz, Oz, 2001, Seismic Data Analysis: Processing, Inversion, and Interpretation of Seismic Data. Page 41-48, Society of Exploration Geophysicists.

### FIGURES

FIG. 1: A shot gather of seismic traces.

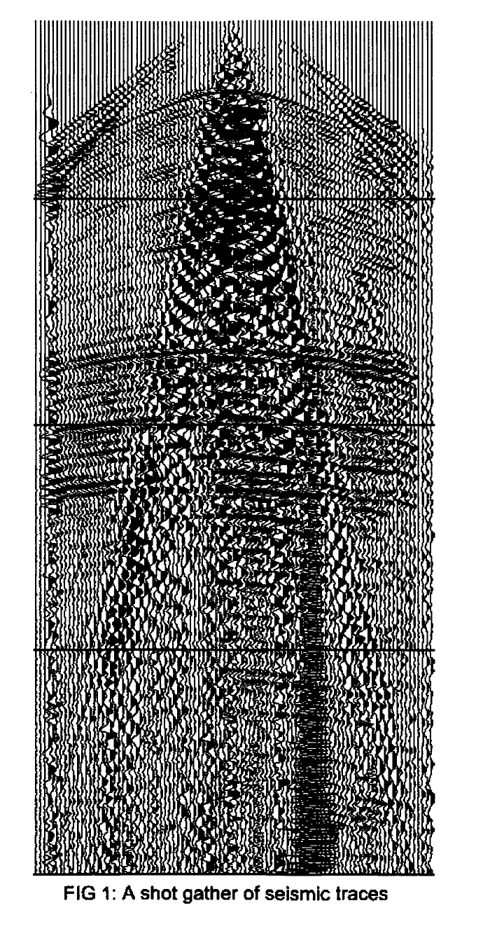

FIG. 2: Reconstruction with wavelets of 16-47 Hz dominant frequency.

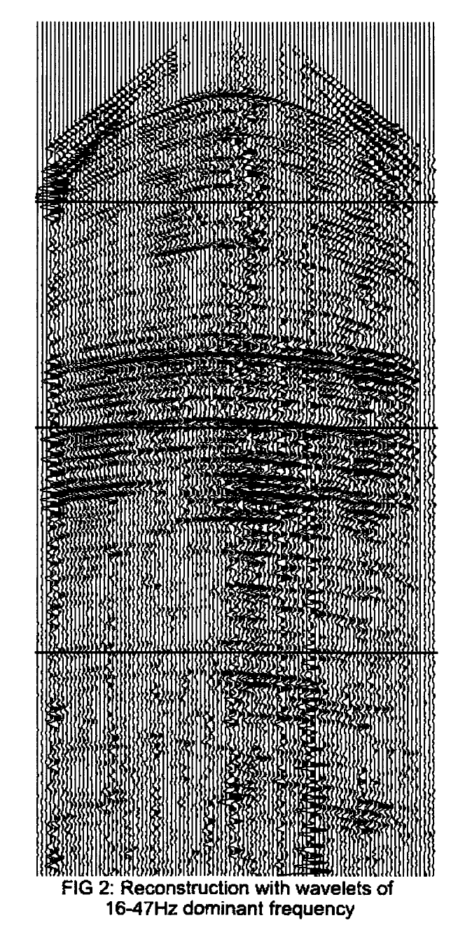

FIG. 3: Difference of seismic data traces before noise removal (FIG. 1) and after noise removal (FIG. 2).

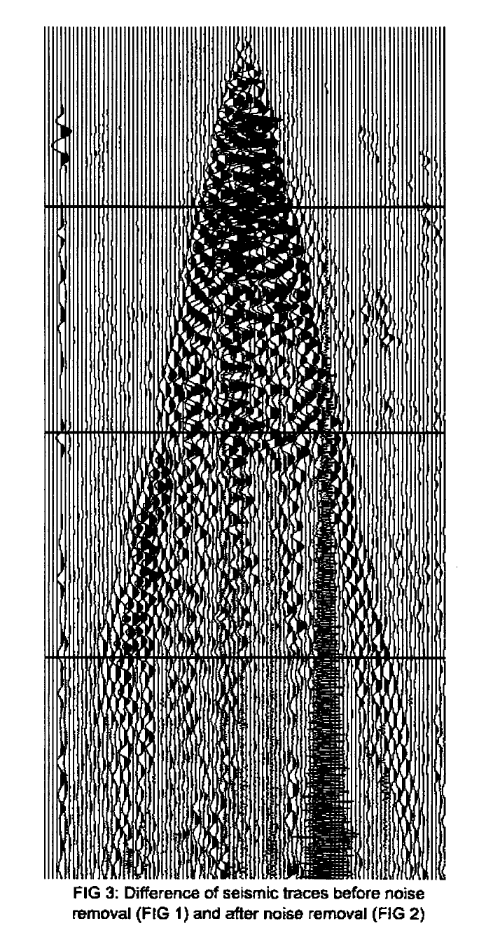

FIG. 4: Reconstruction with wavelets of 2-15 Hz dominant frequency.

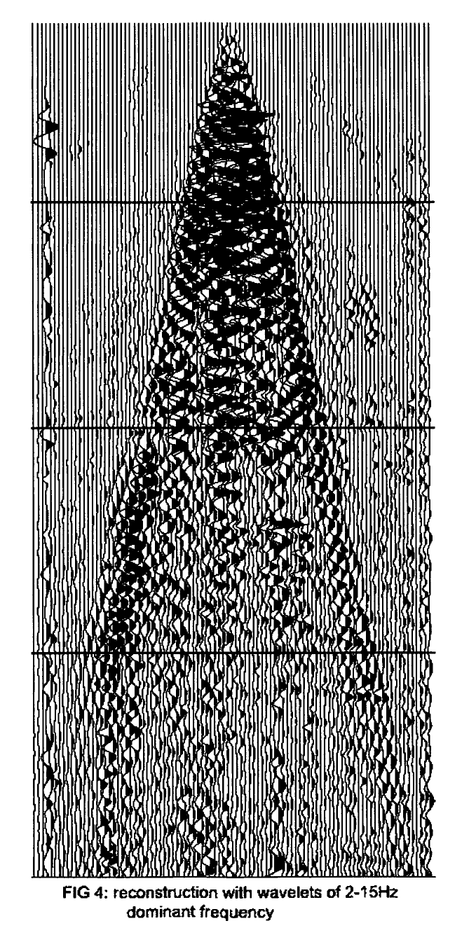

FIG. 5: Reconstruction with wavelets of 48-100 Hz dominant frequency.

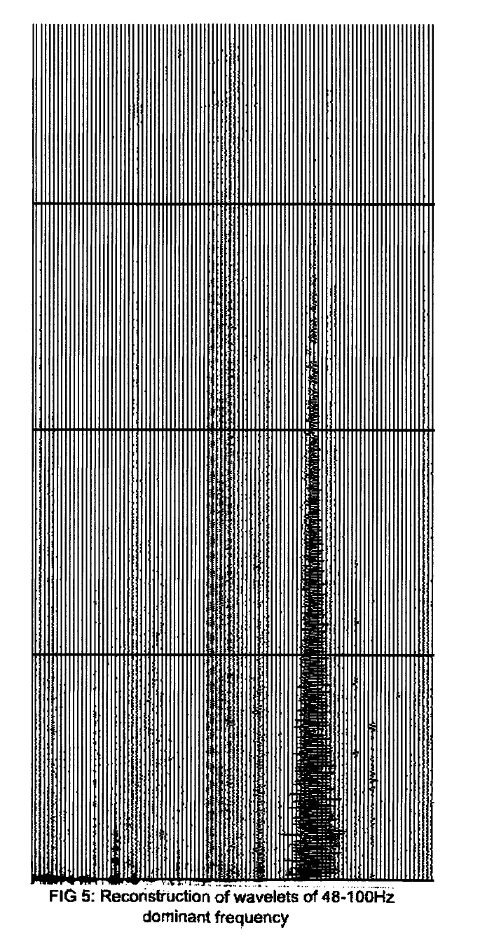

FIG. 6: Result of band pass (11, 16-47, 52) filtering.

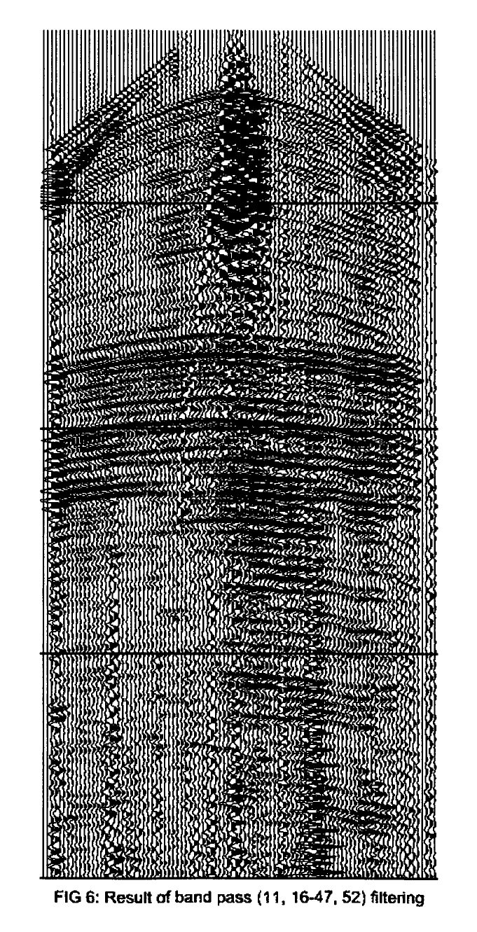

FIG. 7: Difference of original (FIG. 1) from band pass filtering (FIG. 6).

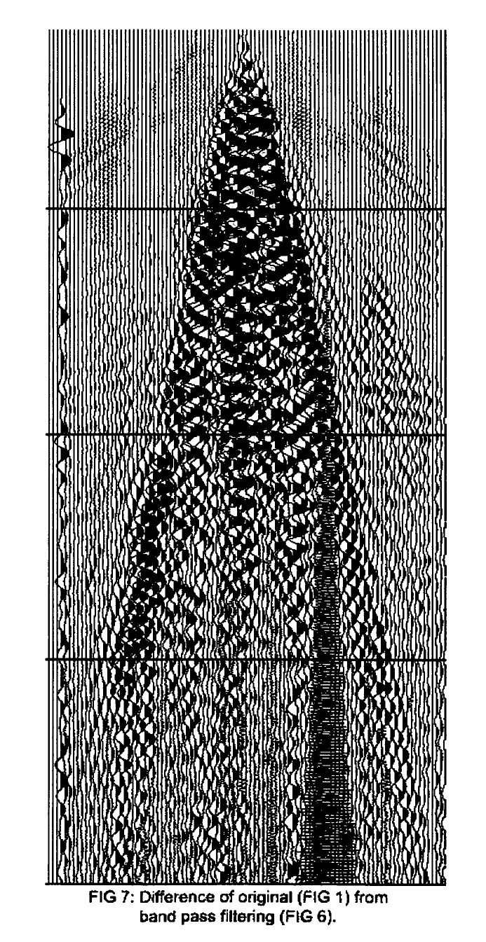

FIG. 8: Result of band pass (18, 23-47, 52) filtering.

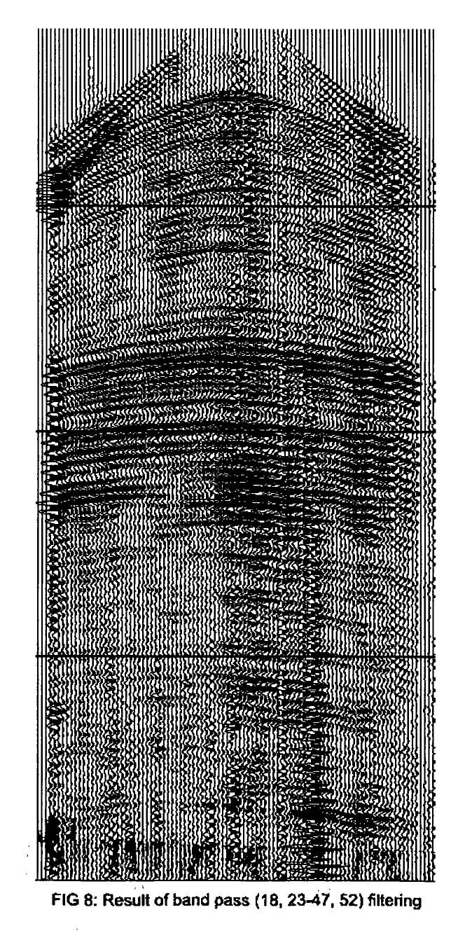

FIG. 9: Difference of original data (FIG. 1) from band pass filtering (FIG. 8).

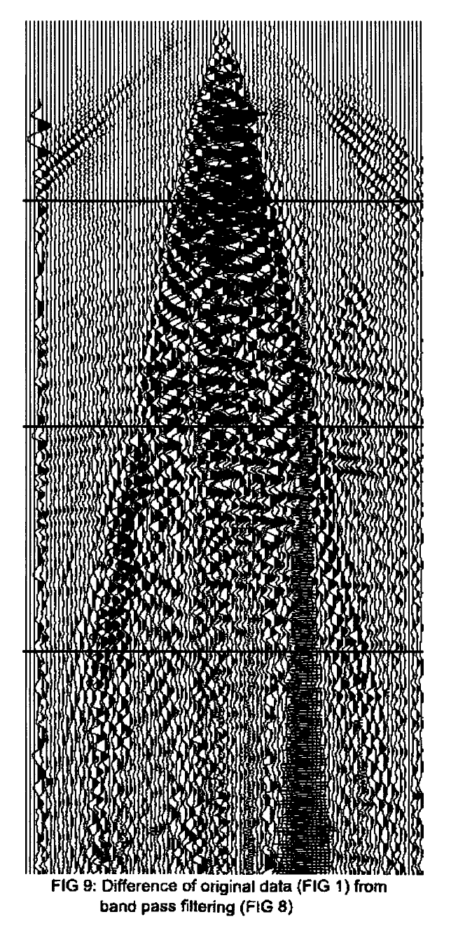

FIG. 10: A shot gather of seismic data traces with low frequency noises.

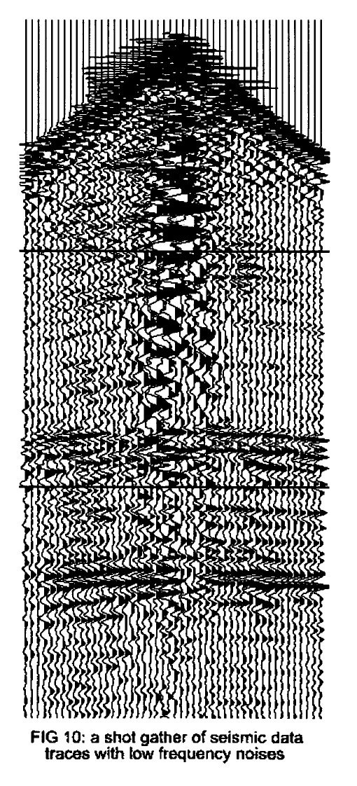

FIG. 11: A polygonal wavelet selection filter in time-frequency domain.

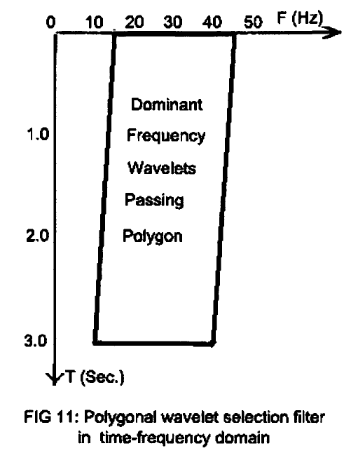

FIG. 12: Reconstruction with selected wavelets by polygonal filter (FIG. 11).

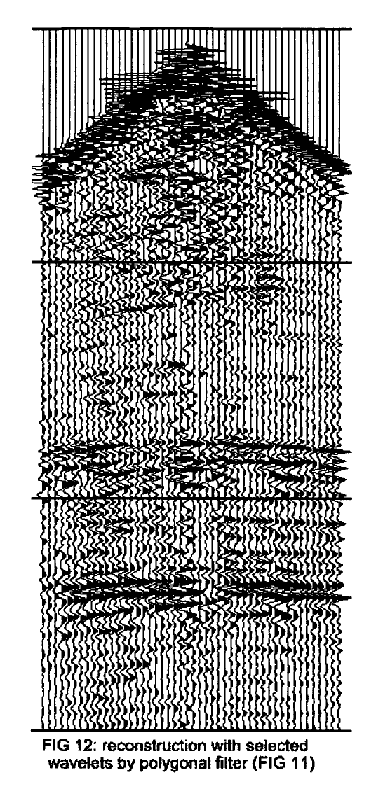

FIG. 13: Difference of polygonal wavelet selection (FIG. 12) from the original (FIG. 10).

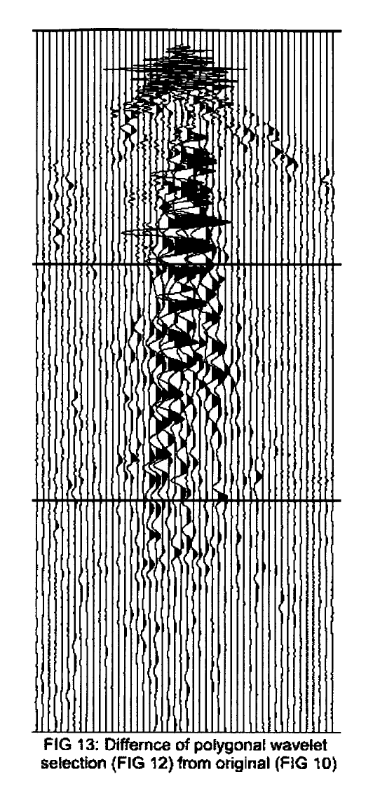

FIG. 14: Result of band pass filtering with band width 10, 15-35, 40 Hz.

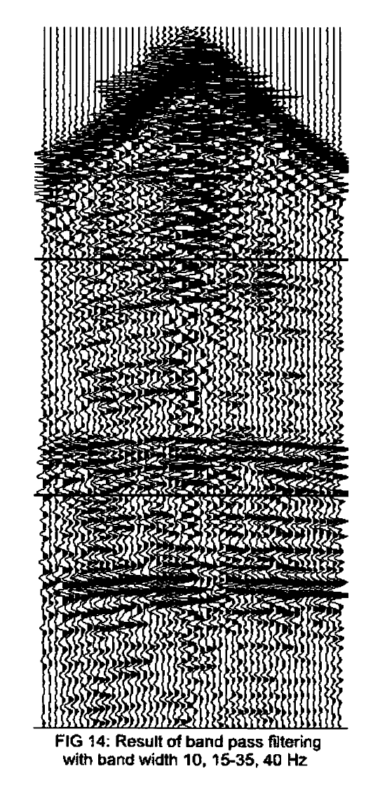

FIG. 15: Difference of band pass filtering (FIG. 14) from the original (FIG. 10).

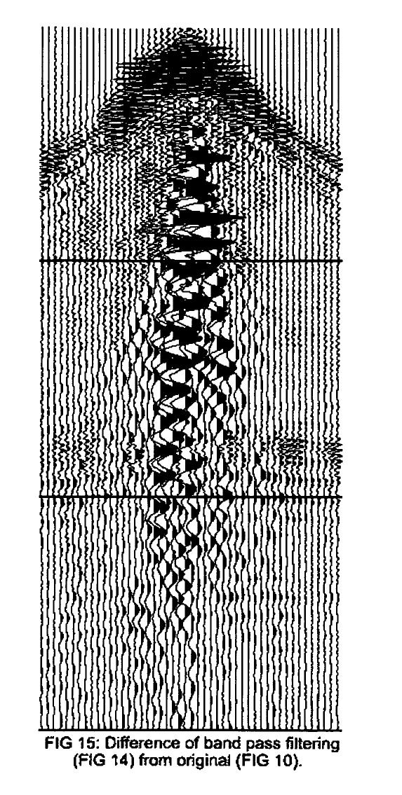

1. (canceled)

2. (canceled)

3. (canceled)

4. (canceled)

5. (canceled)

6. (canceled)

7. (canceled)

8. (canceled)

9. (canceled)

10. (canceled)

11. A method of processing seismic data for interpretation, said method comprising the steps of:
recording an original seismic data trace;
decomposing the original seismic data trace into a set of wavelets of different shapes;
removing noise wavelets from the set of wavelets, thereby forming a new set of wavelets;
reconstructing a seismic data trace from the new set of wavelets.

12. The method of claim 11, wherein said decomposing step includes decomposing the original seismic data trace into a set of Ricker wavelets of a plurality of shapes.

13. The method of claim 12, wherein said decomposing step includes:
establishing a wavelet base containing different wavelet types of extracted wavelets and synthetic wavelets;
dividing the wavelets according to type; and
generating a series of wavelets of different shapes for each wavelet type.

14. The method of claim 12, wherein said reconstructing step includes reconstructing the original seismic data trace.

15. The method of claim 12, wherein the reconstructing step includes reconstructing a new seismic data trace from a subset of the set of wavelets.

16. The method of claim 15, wherein the reconstructing step includes reconstructing the original seismic data trace using all of the wavelets in the set of wavelets.

18. The method of claim 11, wherein the removing step includes excluding wavelets of noise based on wavelet dominant frequencies.

19. The method of claim 18, wherein said removing step includes employing a polygonal wavelet pass in dominant or characteristic frequency and time coordinate plane to select a subset of wavelets.
